(19) United States
(12) Patent Application Publication
(10) Pub. No.: US 2020/0217949 A1
(43) Pub. Date: Jul. 9, 2020

(54) Mock Security Screening and Training Method and Device

(71) Applicant: Joseph Stanfa, Glendale Heights, IL (US)

(72) Inventor: Joseph Stanfa, Glendale Heights, IL (US)

(21) Appl. No.: 16/534,079

(22) Filed: Aug. 7, 2019

Related U.S. Application Data
(60) Provisional application No. 62/788,315, filed on Jan. 4, 2019.

(51) Int. Cl. G01S 13/88; G01S 13/89; G09B 9/54

(52) U.S. Cl. CPC G01S 13/887; G09B 9/54; G01S 13/89

(57) ABSTRACT

A mock security screening and training device including a magnetic board that is designed to replicate the screen of a millimeter wave scanning device. The magnetic board is placed inside of a frame such that the magnetic board can be removed. A plurality of magnet pieces that that represent a highlighted section of a scan. The frame has a storage container attached to a sidewall thereof. The storage container is proportioned to hold the magnetic pieces. The mock screen can represent either a male or a female person to be scanned. The method for using the mock security screening and training device includes placing the magnets on the magnetic board. Interpreting the places which are highlighted by the magnets. Then searching a person that has been staged to correspond to the magnets.

### CROSS REFERENCE TO RELATED APPLICATIONS

This application claims the benefit of U.S. Provisional Application No. 62/788,315 filed on Jan. 4, 2019. The above identified patent application is herein incorporated by reference in its entirety to provide continuity of disclosure.

### BACKGROUND OF THE INVENTION

The present invention relates to a mock security screening and training method and device. More particularly, the present invention provides a mock screen from a security screening method and device that will allow a person to understand how to observe the screen and initiate the proper actions in response.

Personal and national security has become a rising concern over the last 20 years. As a result, things like traveling on an airplane have gone under strict scrutiny when it comes to what may and may not be allowed on the plane. Regardless of the rules, there are people out there who feel the need to place everyone's safety at risk by attempting to take items on a plane that are on the banned list. In some cases, this is an accident and the item is simply taken and the passenger continues with his day. In other cases, the item was intentionally hidden in an attempt to get the item through security screening.

With some people still having the intent to carry items into areas they are not supposed to, it is important that security personnel are properly trained. Proper training can be difficult for a multitude of reasons. It can be difficult to properly stage a training exercise. First it can be difficult to have complete surprise and secrecy when attempting to stage items to be found. Second, it can be extremely costly to have training devices purchased. In many cases, companies cannot afford to purchase an extra security machine just for training purposes. The machines that companies do own are used for actual security screening.

Consequently, there is a need in for an improvement in the art of security screening and training methods. The present invention substantially diverges in design elements from the known art while at the same time solves a problem many people face when attempting to train and understand how a security screening method works. In this regard the present invention substantially fulfills these needs.

### SUMMARY OF THE INVENTION

The present invention provides a mock security screening and training method and device wherein the same can be utilized for providing convenience for the user when attempting to properly train for security jobs especially when the actual equipment may be hard to use for training purposes due to the cost of the machines. The mock security screening and training method includes placing a series of magnets on a mock screen, wherein the screen replicates an actual machine screen. A user can then interpret the mock screen based on the positions of the magnets. A user can then search a staged person in the appropriate areas based on the interpretation of the mock screen.

Another object of the mock security screening and training method is staging a person to be searched, wherein the staged person will mirror the mock screens.

Another object of the mock security screening and training method is selecting a mock screen to place the magnets on.

Another object of the mock security screening and training method is removing the serious of magnets from the mock screen after the staged person has been searched.

Another object of the present invention is a mock security screening and training device including a magnetic board which is designed to replicate a security scanning device screen. A plurality of magnetic pieces removably attached to the magnetic board, wherein the plurality of magnetic pieces represents an alert from the security scanning device.

Another object of the mock security screening and training device is a frame having for sidewalls located around the magnetic board.

Another object of the mock security screening and training device is to have the ability to represent a male or a female on the mock security screening device screen.

Another object of the mock security screening and training device is that the mock screen replicates a millimeter wave scanning device screen.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front view of an embodiment of the mock security screening and training device in a frame.

FIG. 2 shows a front view of an embodiment of the magnetic board with an indicia for the mock security screening and training device.

FIG. 3 shows a flow chart of an embodiment of the mock security screening and training method.

### DETAILED DESCRIPTION OF THE INVENTION

Reference is made herein to the attached drawings. Like reference numerals are used throughout the drawings to depict like or similar elements of the mock security screening and training method and device. For the purposes of presenting a brief and clear description of the present invention, a preferred embodiment will be discussed as used for the mock security screening and training method and device. The figures are intended for representative purposes only and should not be considered to be limiting in any respect.

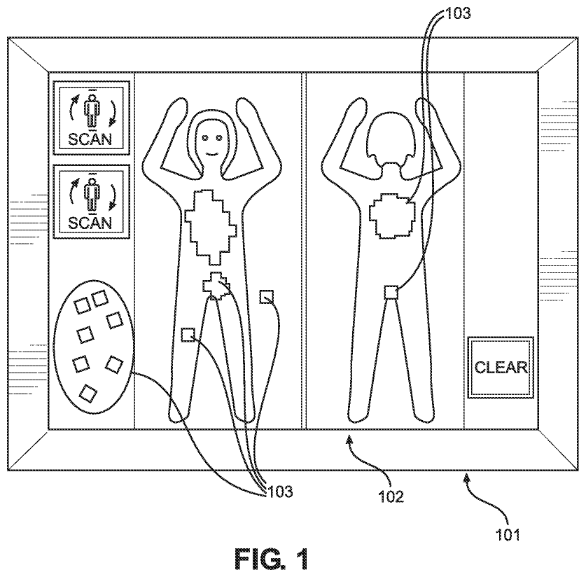

Referring now to FIG. 1, there is shown a front view of an embodiment of the mock security screening and training device in a frame. The mock security screening and training device is comprised of a frame or stand 101, a magnetic board 102, and a plurality of magnets 103. In one embodiment, the mock security screening and training device is designed to replicate a screen from a millimeter wave machine. The frame or stand 101 will have a rectangular shape. In one embodiment the magnetic board 102 is a metal with indicia silk screened on at least one side thereof. When installed, the magnetic board 102 and frame or stand 101 will represent a computer screen.

There is a plurality of magnets 103 than can be magnetically attached to the magnetic board 102. In one embodiment, the magnets 103 are all squares. This will allow for the magnets to be easily fitted together. In this embodiment the square magnets 103 will fit together in order to make other shapes. In one embodiment, the magnets are one color. In one embodiment, the magnets are colored to represent the colors that would be seen on a millimeter wave machine, such that the magnets will represent events on a standard millimeter wave machine.

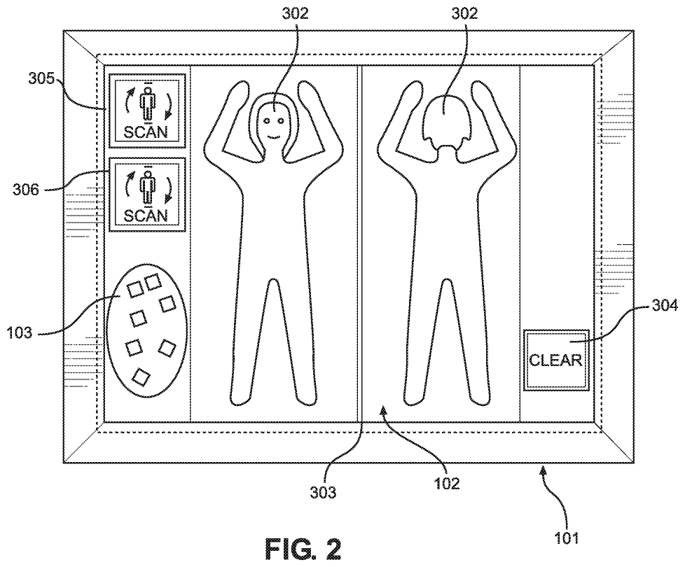

Referring now to FIG. 2, there is shown a front view of an embodiment of the magnetic board with an indicia for the mock security screening and training device. The magnetic board 102 has a nondescript FIG. 302 located there on. The magnetic board 102 displays a front side and a back side of the nondescript FIG. 302 shown thereon. The magnetic board 102 further has a center line 303 shown between the front and back side indicia of the nondescript FIG. 302. There is further, a clear button 304 shown in a right bottom corner thereof. There is a top scan button 305 located in a top left corner of the magnetic board 102. There is further, a bottom scan button 306 located below the top scan button 305 located in the top left corner of the magnetic board 102. In one embodiment, the top scan button 305 is blue. In one embodiment, the bottom scan button is pink. In an embodiment, the color signifies a gender of the real person being scanned. In one embodiment, the center line 303 and the clear button 304 are blue. In this embodiment, the color signifies that the real person being scanned is male. In another embodiment, the center line 303 and the clear button 304 are pink. In this embodiment, the color signifies that the real person being scanned is female. In one embodiment the blue version is on one side of the magnetic board 102 and the pink version is on the other side of the magnetic board 102.

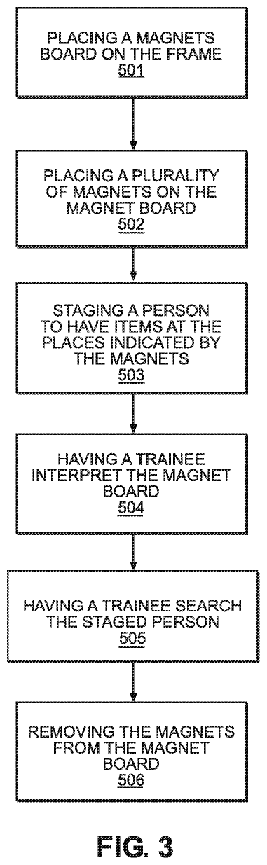

FIG. 3 shows a flow chart of an embodiment of the mock security screening and training method. The method begins when a magnet board is placed in the device frame or stand 101. A plurality of magnets is then placed on the magnet board 502. The magnets should be placed on the figures in order to show places that should be searched by a trainee. A live person is then staged to have anomalies present in areas indicated by the magnets 503. In one embodiment, the anomalies are weapons or other contraband. In another embodiment the anomalies are false alarms, and nothing is placed in the indicated areas. A trainee will then interpret the magnet board 504. The trainee will then conduct a search of the staged person based on his interpretation of the device 505. The method ends when the search is complete and the magnets are removed from the magnet board 506.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A mock security screening and training method, comprising;
placing a series of magnets on a mock screen, wherein the screen replicates a millimeter wave machine screen;
interpreting the mock screen based on a positioning of the series of magnets;
searching a staged person in the appropriate areas based on the interpretation of the mock screen.

2) The mock security screening and training method of claim 1, further comprising staging a person to be searched, wherein the staged person will mirror the mock screens.

3) The mock security screening and training method of claim 1, further comprising selecting a mock screen to place the magnets on.

4) The mock security screening and training method of claim 1, further comprising removing the series of magnets from the mock screen after the staged person has been searched.

5) A mock security screening and training device, comprising:
a magnetic board;
the magnetic board is designed to replicate a security scanning device screen;
a plurality of magnetic pieces removably attached to the magnetic board, wherein the plurality of magnetic pieces represents an alert from the security scanning device.

6) The mock security screening and training device of claim 5, further comprising a frame having for sidewalls located around the magnetic board.

7) The mock security screening and training device of claim 6, wherein the magnetic board is removably secured in the frame.

8) The mock security screening and training device of claim 5, wherein the mock screen replicates a millimeter wave scanning device screen.
